(19) United States
(12) Patent Application Publication
(10) Pub. No.: US 2021/0071450 A1
(43) Pub. Date: Mar. 11, 2021

(54) AUTOMOTIVE DOOR HANDLE DEVICE WITH OPTIMIZED CONNECTOR TECHNOLOGY

(71) Applicant: U-Shin Italia S.p.A., Pianezza (IT)

(72) Inventors: Anthony GUERIN, Pianezza (IT); Regis GRENOUILLAT, Erdweg (DE); Alberto TROPINI, Pianezza (IT); Lukas KALIEBE, Erdweg (DE)

(73) Assignee: U-Shin Italia S.p.A., Pianezza (IT)

(21) Appl. No.: 16/951,368

(22) Filed: Nov. 18, 2020

Related U.S. Application Data
(63) Continuation of application No. PCT/EP2019/062891, filed on May 17, 2019.

(30) Foreign Application Priority Data
May 18, 2018 (FR) 18/54187

(51) Int. Cl. E05B 85/10; E05B 81/76

(52) U.S. Cl. CPC E05B 85/107; E05B 83/36; E05B 81/77

(57) ABSTRACT

A car door handle device includes a handle which can be moved between a retracted position and a deployed position by an actuator. The actuator includes an electric motor and a housing containing the electric motor. The handle device includes electrical components connected to a connector mounted on a housing of the actuator. The connection of the motor and the electrical components with the connector is established by cables that pass through the housing of the actuator.

### CROSS-REFERENCE TO RELATED APPLICATIONS

This application is a continuation of International Application No. PCT/EP2019/062891, filed on May 17, 2019, which claims priority to and the benefit of FR 18/54187, filed on May 18, 2018. The disclosures of the above applications are incorporated herein by reference.

### FIELD

The present disclosure relates to an automotive door handle device provided with electrical components such as a switch, a lighting system, a position sensor, a movement sensor, a proximity sensor, or a printed circuit. The present disclosure also concerns a motor vehicle door equipped with such a handle device, as well as a motor vehicle including such a door.

### BACKGROUND

The statements in this section merely provide background information related to the present disclosure and may not constitute prior art.

Such electrical components are generally connected to one or several connectors via cables, in order to communicate electrical information to a control unit.

In typical handle devices, each electrical component is connected to a respective connector. The multiplicity of electrical components in typical handle devices, and thus the multiplicity of corresponding connectors, tends to weaken the connector technology.

The U.S. Publication No. 2015/0233153 A1 provides an alternative solution consisting in connecting several electrical components of the handle device to a single floating connector. In this device, a portion of the cables is surrounded by a sheath upstream of the connector so as to hold the cables in the shape of a harness and thus reinforce their fastening to the connector.

Typical handle devices have in particular the disadvantage of exposing the cables to water which may be introduced into the handle, for example in the event of bad weather, which can damage the handle device and its operation.

The handle device of the present disclosure addresses these and other issues associated with typical handle devices.

### SUMMARY

This section provides a general summary of the disclosure and is not a comprehensive disclosure of its full scope or all of its features.

The present disclosure includes a handle device for a motor vehicle door, this device including a handle, a transmission mechanism, an actuator, one or several electrical components and a connector as described below.

In one form, the handle of this device is movable between a retracted position and a deployed position. In other words, the handle can be displaced from the retracted position to the deployed position, or from the deployed position to the retracted position, or more generally from a first to a second position, the first and the second position can be the retracted position or the deployed position or any intermediate position between the retracted and the deployed position.

The actuator can include an electric motor and a casing accommodating this motor. This actuator is arranged to displace the handle between the retracted position and the deployed position via the transmission mechanism.

In a non-limiting manner, the electrical component(s) are selected from a switch, a lighting system, a position sensor, a movement sensor, a proximity sensor, a printed circuit, etc.

According to one form, the connector of this device is mounted on the casing, and the motor and the electrical components each include a cable passing through the casing and being connected to the connector in the casing. This connector allows communicating electrical information between, on the one hand, the motor and/or one or several of the electrical components and, on the other hand, a control unit of the handle device.

Such an arrangement of the handle device allows limiting the risk of damage since the end of the cables connected to the connector is housed in the casing. This end and the entire portion of the cables located in the casing are in fact protected by the casing, in particular against water being introduced into the handle.

In addition, such an arrangement allows improving the robustness of the connector technology. The connector is secured to the casing and therefore no effort is exerted on the cables, in particular before connecting the connector.

In one form, the connector can include a receptacle, the casing and this receptacle being molded in one piece. This allows in particular facilitating manufacturing and/or further improving the robustness of the connector technology.

In one form, the handle device can include, as electrical component(s), a position sensor capable of detecting the position of the handle and/or a movement sensor capable of detecting a movement of a finger or a hand of a user on the handle and/or a capacitive proximity sensor capable of detecting a presence of a user near the handle.

According to another form, a motor vehicle door can include a handle device as described above.

In one form, the handle can be flush with the door when the handle is in a retracted position. In one form, this flush handle can be arranged to prevent the displacement of the handle from the retracted position to the deployed position, and/or vice versa, by manual actuation of the handle when the device operates in an automatic mode. In the latter case, the device can also operate in a manual mode, in the event of a malfunction of the device, for example of the motor or of a power battery. In the manual mode, the handle can be displaced manually from the retracted position to the deployed position and vice versa.

According to one aspect, the door can include the control unit of the handle device.

According yet to another form, a motor vehicle can include a door as defined above.

In one form, this vehicle can include a central control unit, this central control unit including the control unit of the handle device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic frontal perspective view of a portion of a door and a handle device mounted on the door according to the teachings of the present disclosure, illustrating a handle of the handle device being in a retracted position;

FIG. 2 is a schematic top view of a portion of the handle device of FIG. 1, showing the handle in a deployed position;

FIG. 3 is a schematic perspective view of a portion of the handle device of FIG. 1;

FIG. 4 is a schematic lateral perspective view of a portion of the handle device of FIG. 1, illustrating the handle being in a deployed position;

FIG. 5 is a schematic side view of a portion of the handle device of FIG. 1, illustrating a portion of an actuating system in accordance with the teachings of the present disclosure;

FIGS. 6 and 7 are schematic views of a handle device of another example according to the teachings of the present disclosure, the handle device including a movement sensor;

FIG. 8 is a schematic view of a handle device of yet another example according to the teachings of the present disclosure, the handle device including a movement sensor and a proximity sensor;

FIG. 9 is a schematic view of a handle device of still another example according to the teachings of the present disclosure, the handle device including a lighting system; and

FIG. 10 is a schematic view of a connector technology of a handle device according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The identical or similar elements are identified by identical reference numerals on all the figures.

In this document, the longitudinal, vertical and transverse terminology will be used without limitation with reference to the trihedron L, V, T indicated in the figures.

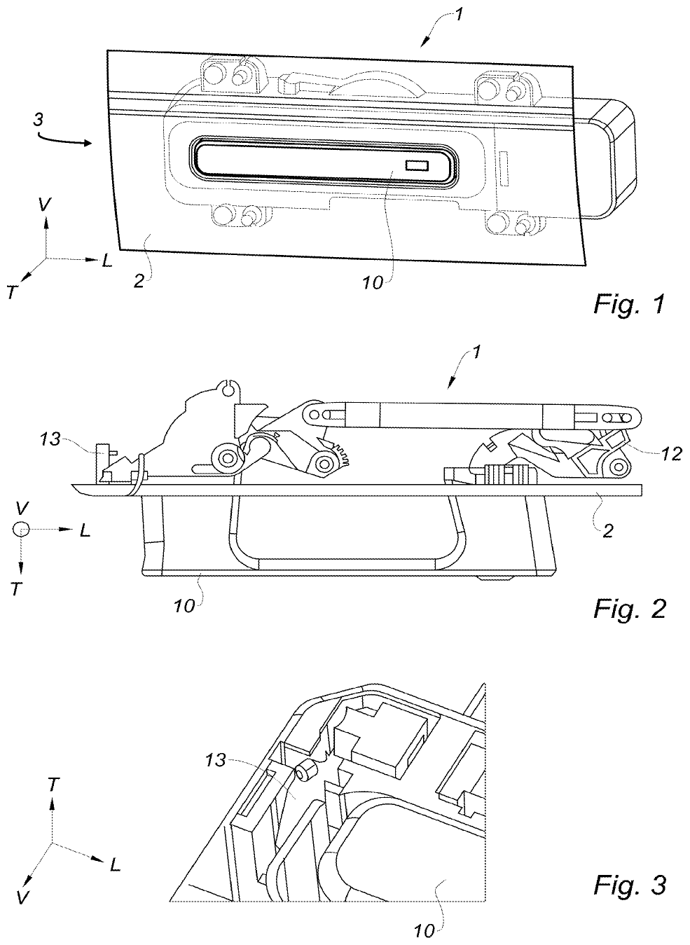

Referring to FIG. 1, a handle device 1 includes a handle 10, illustrated FIG. 1 in a retracted position.

The handle 10 is in this example of the type flush with a door 2 of a motor vehicle 3. This handle 10 is called flush or recessed in the sense that an outer surface of the handle 10 and an outer surface of the door 2 are substantially coplanar when the handle 10 is in a retracted position. Such a recessed handle 1 generally allows improving the aesthetics of the door 2, its opening device 1 being more discreet than a non-flush handle.

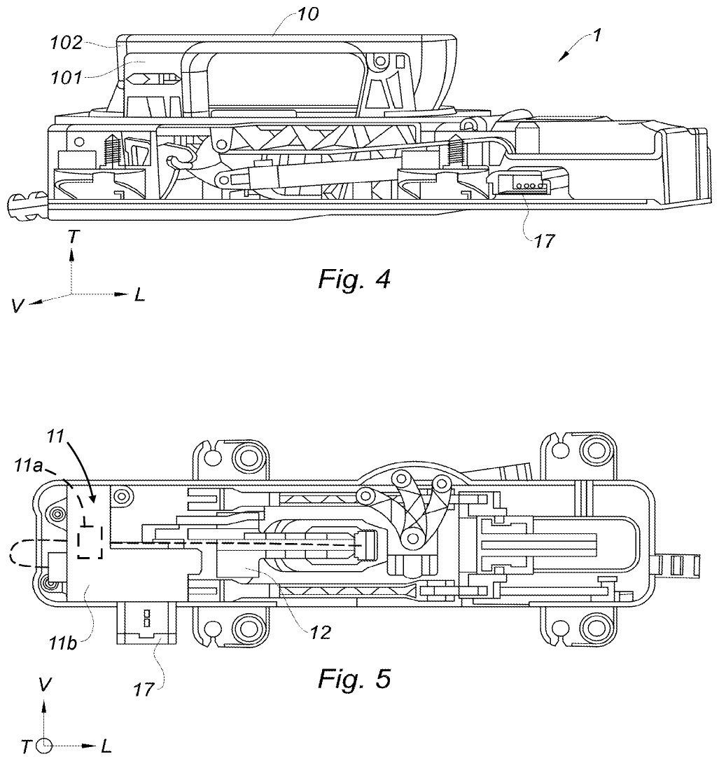

FIGS. 2 and 4 show the handle device 1 in a deployed position. In this deployed position, the handle 10 is arranged so that it can be grasped by a user desiring to open the door 2.

The movement of the handle 10 from the retracted position (FIG. 1) to the deployed position (FIGS. 2 and 4) is carried out by an actuating system. Preferably, this actuating system is designed to operate according to an automatic mode and a manual mode.

In the automatic mode, the handle 10 is deployed via an actuator 11 visible in FIG. 5. This actuator 11 includes an electric motor 11a and a casing 11b accommodating this motor 11a. The actuator 11 is arranged to displace the handle 10 from the retracted position to the deployed position via a transmission mechanism 12 (labeled in FIGS. 2 and 5), for example, when a motor shaft (not shown) is driven in rotation along a first direction of rotation.

Conversely, in the automatic mode, the actuator 11 can also be arranged to displace the handle 10 from the deployed position to the retracted position via this transmission mechanism 12, for example when the motor shaft is driven in rotation along a second direction of rotation opposite to the first direction of rotation.

The transmission mechanism 12 can include any type of known mechanism capable of transmitting a motorized movement from the actuator 11 to the handle 10. In one form, the transmission mechanism 12 can include a gear train allowing reducing the rotational speed of the motor 11a.

The manual mode allows opening the door 2 in the event of malfunction of the device 1. In the manual mode, the actuator 11 and the transmission mechanism 12 are provided so as not to prevent the manual deployment of the handle 10, particularly in the absence of any electric control.

Besides the actuator 11, the device 1 also includes electrical components such as a switch, a lighting system, a position sensor, a movement sensor, a proximity sensor, a printed circuit, etc.

For example, the device 1 can include a position sensor 13 as illustrated in FIGS. 2 and 3. This position sensor 13 allows detecting the position of the handle 10.

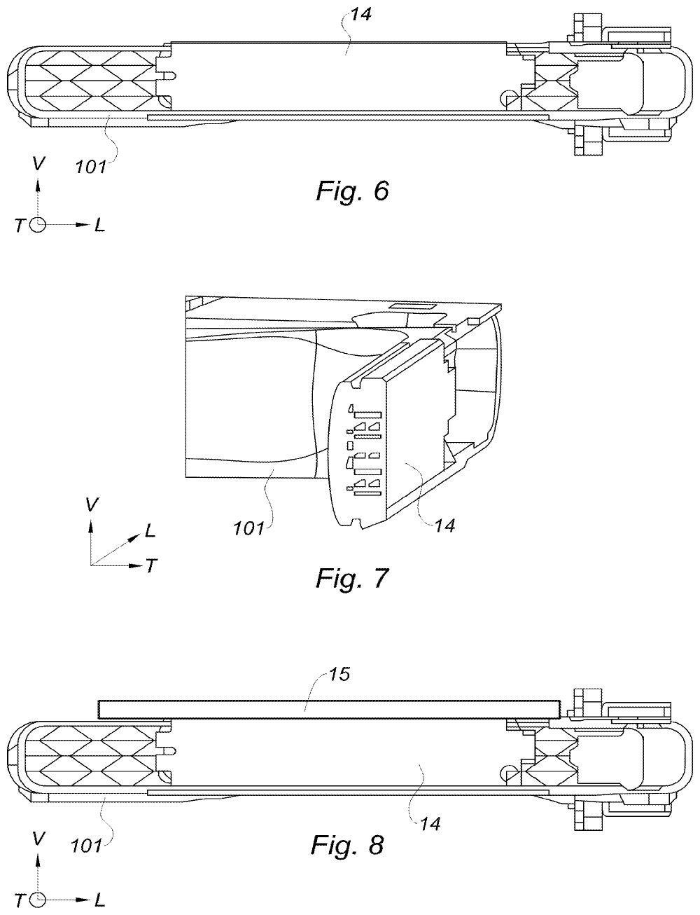

The device 1 can also include a movement sensor 14 as illustrated in FIGS. 6 to 8. This movement sensor 14, located between a support structure 101 of the handle 10 and an outer cover 102 of this handle 10 (see FIG. 4), allows detecting a movement of a finger or a hand of a user on the handle 10.

The device 1 can also include a proximity sensor 15, such as a capacitive sensor, as illustrated in FIG. 8. Such a proximity sensor 15 allows detecting the presence of a user near the handle.

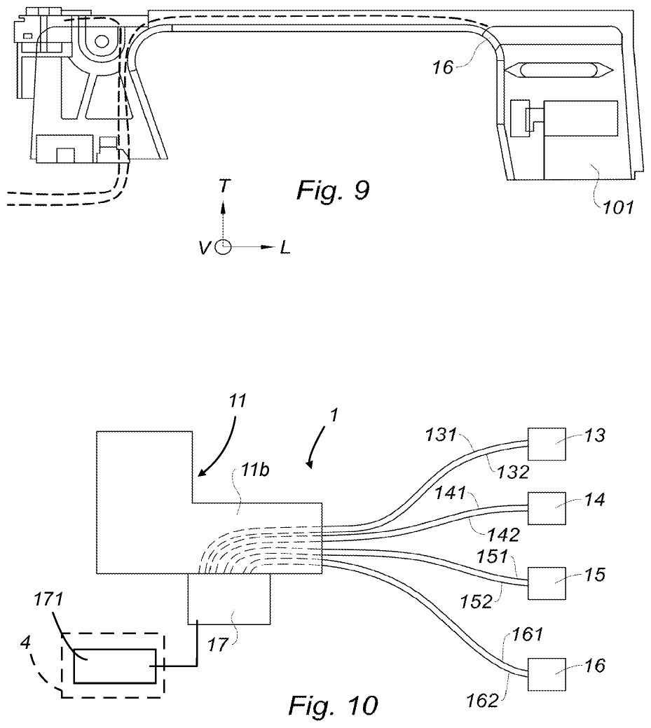

With reference to FIG. 9, the device 1 can also include a lighting system 16 capable of illuminating the handle 10. The lighting is triggered under predetermined conditions, for example when the movement sensor 14 detects a movement of a finger or a hand of a user on the handle 10.

The electrical components given here as an example, are by no means limiting and other configurations of electrical components can be used.

Each of the electrical components equipping the device 1 as well as the motor 11a of the actuator 11 is connected to a control unit 171 (schematically represented in FIG. 10) of the device 1, this control unit 171 can be mounted in the door 2 or constitute a portion of a central control unit 4 (schematically represented in FIG. 10) of the vehicle 3. Such a connection allows communicating electrical information to adequately control the handle device 1 and its different components.

To this end, the motor 11a and the electrical components each include an electrical cable to electrically connect them to the control unit 171 (FIG. 10).

With reference to FIGS. 4 and 5, the device 1 includes a connector 17 to which these electrical cables are connected.

The connector 17 includes a receptacle mounted on the actuator casing 11b. In other words, the connector 17 is secured to this casing 11b. For example, the actuator casing 11b and the receptacle 17 can be molded in a single piece.

The cables of the device 1 connected to the connector 17 pass through the casing 11b of the actuator 11.

This connection principle is shown in FIG. 10 schematically illustrating the device 1 provided with electrical components 13 to 16 of the type described above, each of these components being electrically connected to the connector 17 by a respective pair of cables 131, 132, 141, 142, 151, 152, 161 and 162, passing through the casing 11b of the actuator 11.

The disclosure is not limited to the examples just described, and many adjustments can be made to these examples without going beyond the scope of the disclosure. For example, the handle 10 can be a standard, non-recessed handle. For another example, the electrical components can be of any type mentioned or not in this document, as long as that they are capable of transmitting and/or receiving electrical information via electrical cables passing through the casing 11b of the actuator 11.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handle device for a motor vehicle door, the handle device comprising:
a handle movable between a retracted position and a deployed position;
a transmission mechanism;
an actuator, the actuator comprising an electric motor and a casing accommodating the motor, the actuator being arranged to displace the handle between the retracted position and the deployed position via the transmission mechanism;
at least one electrical component, the at least one electrical component including a switch, a lighting system, a position sensor, a movement sensor, a proximity sensor, a printed circuit, or combinations thereof; and
a connector mounted on the casing,
wherein the motor and the at least one electrical component each include a cable passing through the casing and being connected to the connector in the casing, the connector permitting electrical communication between the motor and a control unit of the handle device, between the at least one electrical component and the control unit, or between the motor and the control unit and between the at least one electrical component and the control unit.

2. The device according to claim 1, wherein the connector comprises a receptacle, the casing and the receptacle being molded in a single piece.

3. The device according to claim 1 further comprising a position sensor capable of detecting the position of the handle.

4. The device according to claim 1 further comprising a movement sensor configured to detect a movement of a finger or a hand of a user on the handle.

5. The device according to claim 1 further comprising a capacitive proximity sensor configured to detect a presence of a user near the handle.

6. A motor vehicle door comprising the handle device according to claim 1.

7. The door according to claim 6, wherein the handle is flush with the door when the handle is in the retracted position.

8. The door according to claim 6 further comprising the control unit of the handle device.

9. A motor vehicle comprising the door according to claim 6.

10. The motor vehicle according to claim 9 further comprising a central control unit, the central control unit comprising the control unit of the handle device.
